(19) United States
(12) Patent Application Publication
(10) Pub. No.: US 2022/0222680 A1
(43) Pub. Date: Jul. 14, 2022

(54) Product Return Task Generating Method, Apparatus, and Device, and Storage Medium

(71) Applicant: Beijing Jingdong Zhenshi Information Technology Co., Ltd., Beijing (CN)

(72) Inventor: Yunfeng Qi, Beijing (CN)

(73) Assignee: Beijing Jingdong Zhenshi Information Technology Co., Ltd., Beijing (CN)

(21) Appl. No.: 17/604,050

(22) PCT Filed: Mar. 20, 2020
(86) PCT No.: PCT/CN2020/080453

§ 371 Date: Oct. 15, 2021

(30) Foreign Application Priority Data
May 8, 2019 (CN) 201910380108.0

(51) Int. Cl. G06Q 30/00

(52) U.S. Cl. CPC G06Q 30/016

(57) ABSTRACT

Provided are a return task generation method and apparatus, a device, and a storage medium. The method includes obtaining purchase information of an item; matching the purchase information with configuration information in a return database, and determining a target return condition corresponding to the item, where the configuration information includes return condition information respectively corresponding to at least one piece of purchase information; and generating a return task corresponding to the item in response to detecting that the target return condition corresponding to the item is met.

This application claims priority to Chinese Patent Application No. 201910380108.0 filed May 8, 2019, the content of which is incorporated herein by reference in its entirety.

### FIELD

This application relates to logistics technology, for example, to a return task generation method and apparatus, a device, and a storage medium.

### BACKGROUND

With the rapid development of e-commerce enterprises, the reverse process of warehouse is constantly perfected. The reverse scenarios presented include, for example, if some items in the warehouse meet the 30-day return condition, the remaining items in the warehouse need to be returned to the supplier within 30 days after the merchant places the order for the items.

In related arts, a return manner of an item is usually that the warehouse personnel manually determines the items to be returned currently to the supplier based on the return conditions of the supplier periodically, and according to the items determined to be returned, manually creates a return task and generates a return document.

There are at least the following issues in the related arts. Due to the numerous operation processes of the warehouse personnel, the warehouse personnel possibly forget or omit the items to be returned to the supplier currently, resulting in failure to return the items in time, thus causing serious economic losses to the company. In addition, the return conditions of the supplier may be changed occasionally, and the information of the return conditions cannot be synchronized in time by means of manual publicity alone, causing that the warehouse personnel cannot perform the return detection according to the up-to-date return conditions, resulting in a return failure, which reduces the return accuracy. Moreover, creating return tasks manually also significantly reduces return efficiency.

### SUMMARY

A return task generation method and apparatus, a device, and a storage medium are provided according to the present disclosure, to improve return efficiency and return accuracy.

A return task generation method is provided according to an embodiment of the present disclosure. The method includes:
obtaining purchase information of an item;
matching the purchase information with configuration information in a return database and determining a target return condition corresponding to the item, specifically, the configuration information includes return condition information respectively corresponding to at least one piece of purchase information; and
generating a return task corresponding to the item in response to detecting that the target return condition corresponding to the item is met.

A return task generation apparatus is further provided according to an embodiment of the present disclosure. The apparatus includes:
a purchase information obtaining module configured to obtain purchase information of an item;
a target return condition determination module configured to match the purchase information with configuration information in a return database and determine a target return condition corresponding to the item; wherein the configuration information includes return condition information respectively corresponding to at least one piece of purchase information; and
a return task generation module configured to generate a return task corresponding to the item in response to detecting that the target return condition corresponding to the item is met.

A device is further provided according to an embodiment of the present disclosure. The device includes:
one or more processors; and
a memory, configured to store one or more programs;
the one or more programs, when executed by the one or more processors, causing the one or more processors to implement the return task generation method according to any embodiment of the present disclosure.

A computer-readable storage medium storing a computer program is further provided according to an embodiment of the present disclosure. The computer program, when executed by a processor, implements the return task generation method according to any embodiment of the present disclosure.

### BRIEF DESCRIPTION OF DRAWINGS

FIG. 1 is a flowchart of a return task generation method according to a first embodiment of the present disclosure;

FIG. 2 is a flowchart of a return task generation method according to a second embodiment of the present disclosure;

FIG. 3 is a schematic structural diagram of a return task generation apparatus according to a third embodiment of the present disclosure; and

FIG. 4 is a schematic structural diagram of a device according to a fourth embodiment of the present disclosure.

### DETAILED DESCRIPTION

The present disclosure is described hereinafter in conjunction with drawings and embodiments.

The embodiments described herein are merely intended to explain, rather than limiting, the present disclosure. For ease of description, only part of the structures rather than all structures related to the present disclosure are illustrated in the drawings.

### First Embodiment

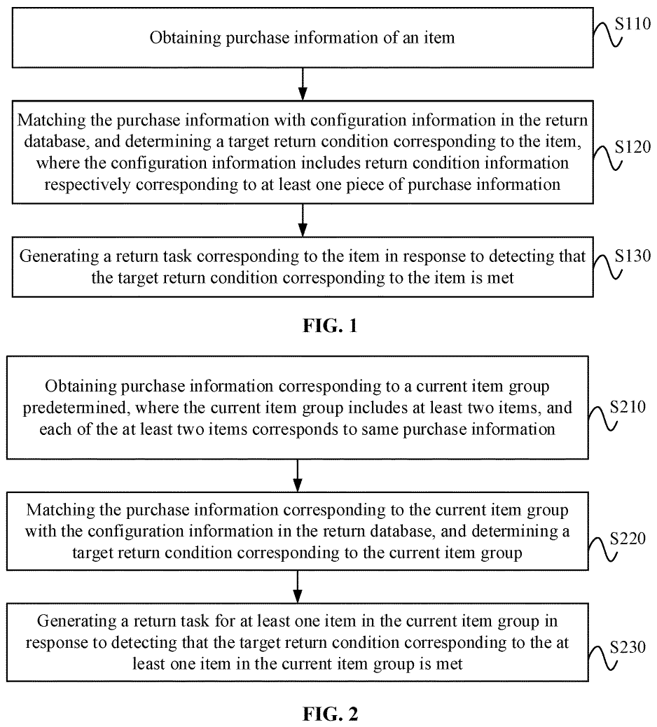

FIG. 1 is a flowchart of a return task generation method according to a first embodiment of the present disclosure, and this embodiment is applicable to a case where a return detection is performed on items in a warehouse to return the item, that currently needs to be returned, to a supplier in time. The method may be performed by a return task generation apparatus, and the apparatus may be implemented by software and/or hardware, and integrated in a device having an information processing function, such as a desktop computer, a laptop, or the like. The method includes steps described below.

In S110, purchase information of an item is obtained.

The item may be any item purchased from the supplier. The purchase information may include but is not limited to at least one of supplier information, purchaser information, and purchase batch information.

In this embodiment, the purchase information of any item stored in the warehouse can be obtained, so as to perform return detection on this item.

In S120, the purchase information is matched with configuration information in a return database, and a target return condition corresponding to the item is determined. The configuration information includes return condition information respectively corresponding to at least one piece of purchase information.

The return database may be used to store the configuration information corresponding to multiple items. The configuration information may include return condition information corresponding to the purchase information of each item. The return condition information corresponding to each piece of purchase information may include but is not limited to at least one return condition. In a case where one piece of purchase information corresponds to multiple return conditions, the return condition information may further include priority information corresponding to each return condition. The return conditions in this embodiment may refer to the conditions to be met for items to be returned, such as the items must be returned within twenty-five days after being purchased, or when an inventory quantity of an item exceeds 500 pieces, an exceeding quantity of the items must be returned, and etc. Return conditions can be defined by the supplier and/or the purchaser based on business scenarios and actual requirements. The return conditions in this embodiment may vary from time to time. When the return condition is changed or a new return condition is added, the configuration information in the return database can be updated or added with the new return condition in real time, so that the return condition information can be dynamically and flexibly configured without relying on manual memory and manual notification.

In an embodiment, the purchase information of the item is matched with multiple pieces of purchase information stored in the return database, the return condition information corresponding to the successfully matched purchase information in the return database is determined based on the correspondence between the return condition information and each piece of purchase information stored in the return database, and the target return condition corresponding to the item is determined according to the return condition information. Since the return condition information stored currently in the return database is the up-to-date information, the target return condition determined based on the return database is the latest and most appropriate return condition corresponding to the item, thereby improving the accuracy of the item return.

In S130, a return task corresponding to the item is generated in response to detecting that the target return condition corresponding to the item is met.

In this embodiment, it may be detected whether a target return condition corresponding to an item is met based on inventory information of the item. For example, in a case where the target return condition is that the return must be performed within 25 days after the purchase, it may be determined whether a holding time of the item exceeds 25 days according to the purchase time of the item and the current time. In a case where the holding time of the item does not exceed 25 days, it indicates that the target return condition corresponding to the item is met. In this case, a return task may be generated according to information such as the inventory quantity of the item and a storage position of the item, so as to return the item. In a case where the target return condition is that the exceeding quantity of the item has to be returned when the inventory quantity of the item exceeds 500, whether the quantity of the item exceeds 500 may be determined according to the inventory quantity of the item. In a case where the quantity of the item exceeds 500, it indicates that the item needs to be returned. In this case, a return task may be generated according to the information such as the return quantity and the storage position of the item, so as to return the item. In this embodiment, whether the item needs to be returned can be automatically detected based on the up-to-date and most appropriate target return condition corresponding to the item, and a return task can be automatically generated in response to detecting that the item needs to be returned, thereby improving return accuracy and return efficiency.

In the technical solution of this embodiment, the return condition information corresponding to the purchase information of multiple items respectively is stored and configured by using the return database, so that the return condition information can be dynamically and flexibly configured when the return condition is changed, without relying on manual memory and manual notification. In addition, by matching the purchase information of the item with the configuration information in the return database, the target return condition corresponding to the item can be automatically determined, such that return detection is performed on the item based on the up-to-date and most appropriate target return condition, and when the target return condition is met, the return task corresponding to the item can be automatically generated. Therefore, an entire process of return task generation does not require manual participation, and the return task generation is automated, thereby improving return efficiency and return accuracy.

On the basis of the above technical solution, the return database may include a master table of purchase information configuration and a secondary table of return condition. The master table of purchase information configuration is used to store at least one piece of purchase information; and the secondary table of return condition is used to store at least one piece of return condition information corresponding to each piece of purchase information.

In this embodiment, the return database can be designed by using a relationship between a master table and a secondary table, so that the configuration is more concise, the data storage space is saved, and the data query efficiency of the return database is improved. The master table of purchase information configuration and the secondary table of return condition can be associated through a purchase information identifier. Table 1 provides an example of the master table of purchase information configuration. Table 2 provides an example of the secondary table of return condition. As shown in Table 1, each piece of purchase information in the master table of purchase information configuration may include a supplier brevity code, a supplier name, a purchaser code, a purchaser name, and a purchase batch number. As shown in Table 2, the purchase information of the purchase information identification 1001 corresponds to three pieces of return condition information, and each piece of return condition information may include a return condition identifier (ID), a return condition code, a return condition content, and a priority weight. The priority weight is higher, the priority of the return condition is higher.

TABLE 1
Master Table of Purchase Information Configuration

| Purchase | | | | | |
|---|---|---|---|---|---|
| information | Supplier | | | | |
| identification | brevity | Supplier | Purchaser | Purchaser | Batch |
| ID | code | name | code | name | number |
| 1001 | bjazsm | Beijing | wangyiheng | Wang | 300314 |
| | | Shenzhou | | Yiheng | |
| | | Digital | | | |
| 1002 | bjglkt | Beijing | liwenwen | Li | 400545 |
| | | Gree air | | Wenwen | |
| | | conditioner | | | |

. . .

TABLE 2
Secondary Table of Return Condition

| Return | Purchase | | | |
|---|---|---|---|---|
| condition | information | Return | Return | |
| identification | identification | condition | condition | Priority |
| ID | ID | code | content | weight |
| 2001 | 1001 | 25d | Return within 25- | 100 |
| | | | day after purchase | |

. . .

| | | | | |
|---|---|---|---|---|
| 3001 | 1001 | 500j | Return when | 50 |
| | | | exceeding 500 pieces | |

. . .

| | | | | |
|---|---|---|---|---|
| 4001 | 1001 | jk | Return before the | 1000 |
| | | | expiration of contract | |

For example, in a case where the return database includes the master table of purchase information configuration and the secondary table of return condition, S120 may include: the purchase information of the item is matched with multiple pieces of purchase information in the master table of purchase information configuration, and determining a purchase information identifier corresponding to successfully matched purchase information; querying, in the secondary table of return condition, a candidate return condition corresponding to the purchase information identifier; in response to finding that at least two candidate return conditions exist, determining a target return condition corresponding to the item according to priority information corresponding to each candidate return condition of the at least two candidate return conditions.

In an embodiment, when the purchase information of the item is matched with the configuration information in the return database, the purchase information of the item may be first matched with multiple pieces of purchase information in the master table of purchase information configuration. When all the information such as the supplier brevity code, supplier name, purchaser code, purchaser name, and purchase batch number is successfully matched, the purchase information identifier corresponding to the successfully matched purchase information may be determined. Then, a query is performed in the secondary table of return condition by using the purchase information identifier, so that multiple return conditions, corresponding to the purchase information identifier, in the secondary table of return condition can be obtained. The multiple return conditions obtained by the query are used as the candidate return conditions. In response to finding that only one candidate return condition exist, the candidate return condition can be directly determined as the target return condition corresponding to the item. In response to finding that at least two candidate return conditions exist, priority information, such as the priority weight, corresponding to each candidate return condition of the at least two candidate return conditions may be obtained from the secondary table of return condition, and the multiple candidate return conditions may be ordered based on the priority information. In this case, the candidate return condition with the highest priority weight value may be determined as the target return condition. In response to finding that at least two candidate return conditions having same priority weight exist, a candidate return condition with a higher hot value may be determined as the target return condition corresponding to the item according to a usage frequency of each candidate return condition of the at least two candidate return conditions, i.e., the hot value corresponding to each candidate return condition of the at least two candidate return conditions.

On the basis of the above technical solution, after the return task corresponding to the item is generated, the method further includes: a sorting device is controlled to sort the item based on the return task; and when the sorting is completed, a return device is controlled to perform return operation to the sorted item.

The sorting device may include, but is not limited to, a sorting robot or a sorting robot arm. The return device may include, but is not limited to, a packing robot, a transport robot, a loading device, a distribution vehicle, and the like.

In an embodiment, after a return task of the item is generated, the sorting device may be controlled to sort out all the items in the return task, and after the sorting is completed, the packing robot may be controlled to pack the sorted items, the transportation robot may be controlled to transport the packed items to a loading position, and the loading device may be controlled to automatically load the items into the distribution vehicle, so that the automatic sorting and dispatching operation of the items may be realized, and the return efficiency of the items may be improved.

### Second Embodiment

FIG. 2 is a flowchart of a return task generation method according to a second embodiment of the present disclosure. In this embodiment, a method for performing return detection on multiple items in a warehouse is described on the basis of the above-described embodiment. The terms which are same as or corresponding to those in the above-described embodiments would not be repeated herein.

Referring to FIG. 2, the return task generation method according to this embodiment includes the following steps.

In S210, purchase information corresponding to a current item group predetermined is obtained. The current item group includes at least two items, and each of the at least two items corresponds to same purchase information.

In an embodiment, when return detection is performed on multiple items in the warehouse, the multiple items may be grouped based on the purchase information of the items to obtain multiple item groups. The multiple items in each item group correspond to same purchase information. The current item group may refer to any one of the item groups. The purchase information corresponding to the current item group is also the purchase information corresponding to the multiple items in the current item group.

By way of example, S210 may include combining and grouping the multiple items according to the purchase information of the multiple items and based on multiple purchase parameters, and determining multiple item groups and purchase information corresponding to the current item group in the multiple item groups.

The purchase parameters may refer to but are not limited to a supplier, a purchaser and a purchase batch number.

In an embodiment, in a case where for a same purchase batch number, a purchaser purchases multiple items from a supplier, such that these items have same purchase information, therefore, all the multiple items can be combined and grouped based on multiple purchase parameters to determine multiple items corresponding to a same piece of purchase information. In this embodiment, all the multiple items may be combined and grouped based on the purchase parameters one by one. For example, in a case where the multiple purchase parameters are a supplier, a purchaser and a purchase batch number, all the multiple items may be grouped and combined first according to the purchase parameter of the supplier to determine a first item group corresponding to each supplier. In this case, the multiple items in the first item group have same supplier. Then, the multiple items in each first item group are grouped and combined based on the purchase parameter of the purchaser, to determine a second item group corresponding to each purchaser in each first item group. In this case, multiple items in the second item group have same supplier and same purchaser. Finally, the multiple items in each second item group are grouped and combined based on the purchase parameter of the purchase batch number, to determine a third item group corresponding to each purchase batch number in each second item group. In this case, multiple items in the third item group have same supplier, same purchaser, and same purchase batch number. Thus, each of the determined third item groups may be determined as a current item group one by one.

In S220, the purchase information corresponding to the current item group is matched with the configuration information in the return database, and determine the target return condition corresponding to the current item group.

In this embodiment, by taking the item group as a unit, and matching the purchase information corresponding to the current item group with multiple pieces of purchase information in the return database and based on the correspondence between each piece of purchase information and the return condition information, the target return condition corresponding to the current item group is determined. The target return condition corresponding to the current item group in this embodiment may be a return condition according to which return detection is performed on each item in the current item group. For example, when the current item group determined according to the return database corresponds to multiple candidate return conditions, and the multiple candidate return conditions have same priority weight, all of the candidate return conditions may be determined as the target return conditions corresponding to the current item group in a case where the quantity of the candidate return conditions is less than a preset quantity. These multiple target return conditions may be cycled to determine the target return condition corresponding to each item in the current item group, so as to improve flexibility in determining the target return condition. By determining the target return condition corresponding to the item group, the target return condition corresponding to each item in the item group can be obtained, and there is no need to perform data matching in the return database for each item one by one, so that the return efficiency can be improved.

In S230, a return task for at least one item in the current item group is generated in response to detecting that the target return condition corresponding to the at least one item is met.

In an embodiment, it is detected whether the target return condition corresponding to each item in the current item group is met based on the target return condition corresponding to the current item group, and a return task is generated based on all items whose respective target return conditions are met, so that one or more items can be returned together, thereby improving return efficiency.

By way of example, S230 may include detecting whether the target return condition corresponding to each item in the current item group is met according to inventory information of each respective item in the current item group; and according to the inventory information corresponding to each target item whose respective target return condition is met, generating at least one return task corresponding to the target item.

The inventory information of an item may include, but is not limited to, at least one of inventory quantity, purchase time, warehouse entry time, invoice time, and price of the item. In an embodiment, each target item, whose respective target return condition is met, that is, the target item that needs to be returned in the current item group, is determined based on the target return condition corresponding to the current item group and the inventory information corresponding to each item in the current item group. The return information corresponding to each target item, such as the quantity of the item to be returned, is determined according to the inventory information of the target item, and one or more return tasks are generated according to the return information corresponding to each target item. For example, when the quantity of the item to be returned exceeds the capacity of one distribution vehicle, multiple return tasks can be generated to use multiple distribution vehicles for return.

By way of example, after the target item, whose respective target return condition is met, in each item group is determined, the information of the target item may be pushed in a message queue to a module for generating the return task so that the programs communicate with each other by sending data in messages instead of directly calling the interface, thereby improving the push efficiency and the generation efficiency of the return task.

In the technical solution of this embodiment, an item group is taken as a unit, the target return condition corresponding to an item group predetermined is determined according to the purchase information corresponding to the item group, so that the target return condition corresponding to each item in the item group can be obtained, and there is no need to perform data matching in the return database for each item one by one, so that the return efficiency can be improved.

The following is an embodiment of a return task generation apparatus according to the present disclosure, the apparatus has a same invention concept as that of the return task generation method of the above described embodiments, and the content, which is not described in the embodiment of the return task generation apparatus, may be referred to the embodiments of the return task generation method.

### Third Embodiment

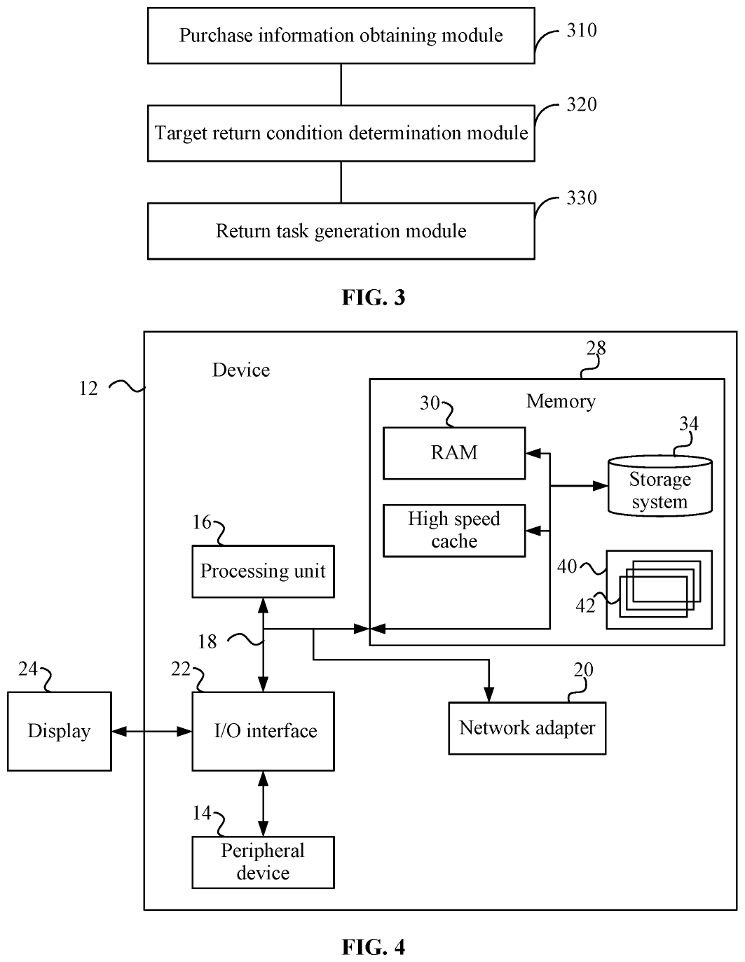

FIG. 3 is a schematic structural diagram of a return task generation apparatus according to a third embodiment of the present disclosure. The return task generation apparatus according to this embodiment can be applied to the situation where return detection is performed on items in the warehouse, so that the items that currently need to be returned can be returned to the supplier in time. The apparatus includes a purchase information obtaining module 310, a target return condition determination module 320, and a return task generation module 330.

The purchase information obtaining module 310 is configured to obtain purchase information of an item. The target return condition determination module 320 is configured to match the purchase information with configuration information in the return database, and determine a target return condition corresponding to the item. The configuration information includes return condition information respectively corresponding to at least one piece of purchase information. The return task generation module 330 is configured to generate a return task corresponding to the item in response to detecting that the target return condition corresponding to the item is met.

Optionally, the return database includes a master table of purchase information configuration and a secondary table of return condition; the master table of purchase information configuration is used to store at least one piece of purchase information; and the secondary table of return condition is used to store at least one piece of return condition information corresponding to each piece of purchase information.

Optionally, the target return condition determination module 320 is configured to: match the purchase information of the item with multiple pieces of purchase information in the master table of purchase information configuration, and determine a purchase information identifier corresponding to successfully matched purchase information; query, in the secondary table of return condition, a candidate return condition corresponding to the purchase information identifier; and in response to finding that at least two candidate return conditions exist, determine a target return condition corresponding to the item according to the priority information corresponding to each candidate return condition of the at least two candidate return conditions.

Optionally, the purchase information obtaining module 310 is configured to obtain purchase information corresponding to a current item group predetermined. The current item group includes at least two items, and the at least two items correspond to same purchase information.

The target return condition determination module 320 is configured to: match the purchase information corresponding to the current item group with the configuration information in the return database, and determine a target return condition corresponding to the current item group.

The return task generation module 330 is configured to generate a return task for at least one item in the current item group in response to detecting that the target return condition corresponding to the at least one item is met.

Optionally, the purchase information obtaining module 310 is configured to: combine and group multiple items according to the purchase information of the multiple items and based on multiple purchase parameters, and determine multiple item groups and purchase information corresponding to a current item group in the multiple item groups.

Optionally, the return task generation module 330 is configured to: detect whether the target return condition corresponding to each item in the current item group is met according to inventory information of each respective item in the current item group; and, generate at least one return task corresponding to each target item whose respective target return condition is met according to the inventory information corresponding to the target item.

Optionally, the apparatus further includes:

a sorting device control module, which is configured to control a sorting device to sort the item based on the return task corresponding to the item after the return task is generated; and a return device control module, which is configured to control a return device to perform a return operation on the item sorted when the sorting is completed.

The return task generation apparatus according to the embodiment of the present disclosure can execute the return task generation method according to any embodiment of the present disclosure, and has corresponding functional modules for executing the return task generation method and corresponding effects to that of the return task generation method.

### Fourth Embodiment

FIG. 4 is a schematic structural diagram of a device according to a fourth embodiment of the present disclosure. FIG. 4 shows a block diagram of a device 12 suitable for implementations of the present disclosure as an exemplary. The device 12 shown in FIG. 4 is merely an example and should not be deemed as imposing any limitations on the functionality and scope of use of the embodiment of the present disclosure.

As shown in FIG. 4, the device 12 is represented in the form of a general purpose computing apparatus. Components of the device 12 may include, but are not limited to, one or more processors or processing units 16, a system memory 28 and a bus 18 connecting different system components (including the system memory 28 and the processing unit 16).

The bus 18 represents one or more of several types of bus structures, including a memory bus or a memory controller, a peripheral bus, a graphics acceleration port, a processor, or a local bus using any of a variety of bus structures. For example, these architectures include, but are not limited to, an industry standard architecture (ISA) bus, a micro channel architecture (MAC) bus, an enhanced ISA bus, a video electronics standards association (VESA) local bus, and a peripheral component interconnect (PCI) bus.

The device 12 typically includes multiple types of computer system readable medium. These media may be any available medium that can be accessed by the device 12. These media include a volatile medium, a non-volatile medium, a removable medium or a non-removable medium.

The system memory 28 may include a computer system-readable medium in the form of volatile memory, such as a random access memory (RAM) 30 and/or a cache memory 32. The device 12 may include other removable/non-removable, volatile/non-volatile computer system storage medium. For example only, the storage system 34 may be configured to read and write a non-removable medium, or a non-volatile magnetic medium (not shown in FIG. 4, commonly referred to as a “hard drive”). Although not shown in FIG. 4, a magnetic disk drive configured to read and write a removable non-volatile magnetic disk (e.g., floppy disk) and an optical disk drive configured to read and write a removable non-volatile optical disk (e.g., a compact disc-read only memory, (CD-ROM), a digital versatile disk read-only memory (DVD-ROM), or other optical media) may be provided. In these cases, each drive may be connected to the bus 18 via one or more data media interfaces. The system memory 28 may include at least one program product having a set of (e.g., at least one) program modules configured to perform the functions of the embodiments of the present disclosure.

A program/utility 40, having a set of (at least one) program modules 42, may be stored, for example, in the system memory 28. Such program modules 42 include, but are not limited to, an operating system, one or more application programs, other program modules, or program data, any one or a combination of which may include an implementation of a network environment. The program modules 42 generally perform the described functions and/or methods in the embodiments of the present disclosure.

The device 12 may communicate with one or more peripheral devices 14 (for example, a keyboard, a pointing terminal, or a display 24), may communicate with one or more terminals that enable a user to interact with the device 12, and/or may communicate with any device (for example, a network interface controller or a modem) that enables the device 12 to communicate with one or more other computing devices. Such communication may be performed through an input/output (I/O) interface 22. Further, the device 12 may also communicate with one or more networks, such as a local area network (LAN), a wide area network (WAN), and/or a public network, such as the Internet, through a network adapter 20. As shown, the network adapter 20 communicates with other modules of the device 12 via the bus 18. It is to be understood that although not shown in the figures, other hardware and/or software modules may be used in conjunction with the device 12. The other hardware and/or software modules include, but are not limited to, microcodes, a terminal driver, a redundant processing unit, an external disk drive array, a redundant arrays of independent disks (RAID) system, a tape driver, a data backup storage system and the like.

The processing unit 16 runs a program stored in the system memory 28, to execute multiple functional applications and perform data processing, for example, implementing the steps of a return task generation method according to any embodiment of the present disclosure, which includes:

obtaining purchase information of an item; matching the purchase information with configuration information in a return database, determining a target return condition corresponding to the item, where the configuration information includes return condition information respectively corresponding to at least one piece of purchase information; and in response to detecting that a target return condition corresponding to the item is met, generating a return task corresponding to the item.

The processor may also implement the technical solution of the method for determining the amount of retained inventory according to any embodiment of the present disclosure.

### Fifth Embodiment

It is provided according to the fifth embodiment a computer-readable storage medium storing a computer program. When the computer program is executed by a processor, steps of a return task generation method according to any embodiment of the present disclosure are implemented, the method includes:

obtaining purchase information of an item; matching the purchase information with configuration information in a return database, and determining a target return condition corresponding to the item, where the configuration information includes return condition information respectively corresponding to at least one piece of purchase information; and in response to detecting that a target return condition corresponding to the item is met, generating a return task corresponding to the item.

The computer storage medium in embodiments of the present disclosure may be embodied as one computer-readable medium or any combination of multiple computer-readable media. The computer-readable medium may be a computer-readable signal medium or a computer-readable storage medium. The computer-readable storage medium may be, but is not limited to, an electrical, magnetic, optical, electromagnetic, infrared or semiconductor system, apparatus or component, or any combination thereof. Examples of computer-readable storage medium include (a non-exhaustive list): electrical connections having one or more wires, portable computer disks, hard disks, random access memories (RAMs), read-only memories (ROMs), erasable programmable read-only memories (EPROMs, or flash memories), optical fibers, portable compact disk read-only memories (CD-ROM), optical storage component, magnetic storage component, or any suitable combination thereof. Herein, the computer-readable storage medium may be any tangible medium including or storing a program. The program may be used by or used in conjunction with an instruction execution system, apparatus or component.

The computer-readable signal medium may include a data signal propagated in a baseband or a data signal propagated as part of a carrier. The data signal carries computer-readable program codes. The data signal may be propagated in multiple forms, which include but are not limited to, an electromagnetic signal, an optical signal, or any suitable combination thereof. The computer-readable signal medium may further be any computer-readable medium besides the computer-readable storage medium. The computer-readable medium can send, propagate, or transmit the program used by or used in conjunction with the instruction execution system, device, or component.

The program codes included in the computer-readable medium may be transmitted in any suitable medium, including, but not limited to, a wireless medium, a wired medium, an optical cable, radio frequency (RF), and the like, or any suitable combination thereof.

Computer program codes for performing the operations of the present disclosure may be written in one or more programming languages or a combination thereof, and the programming languages include object-oriented programming languages such as Java, Smalltalk, C++, and further include conventional procedural programming languages such as “C” programming language or similar programming languages. The program codes may be executed entirely on a user computer, may be executed partly on the user computer, may be executed as a stand-alone software package, may be executed partly on the user computer and partly on a remote computer, or may be executed entirely on the remote computer or a server. In a case involving a remote computer, the remote computer may be connected to the user's computer through any kinds of network, including a local area network (LAN) or a wide area network (WAN), or may be connected to an external computer (e.g., connected through Internet by using an Internet service provider).

The above-described modules or steps of the present disclosure may be implemented by a general-purpose computing apparatus, they may be centralized on a single computing apparatus or distributed over a network composed of multiple computing apparatuses, optionally they may be implemented by program codes executable by the computer apparatus, so that they may be stored in a memory and executed by the computing apparatus, or they may be separately fabricated into multiple integrated circuit modules, or multiple modules or steps thereof may be fabricated into a single integrated circuit module. In this way, the present disclosure is not limited to any specific combination of hardware and software.

1. A return task generation method, comprising:
obtaining purchase information of an item;
matching the purchase information with configuration information in a return database, and determining a target return condition corresponding to the item; wherein the configuration information comprises return condition information respectively corresponding to at least one piece of purchase information; and
generating a return task corresponding to the item in response to detecting that the target return condition corresponding to the item is met.

2. The method of claim 1, wherein the return database comprises a master table of purchase information configuration and a secondary table of return condition; wherein,
the master table of purchase information configuration is used to store at least one piece of purchase information; and
the secondary table of return condition is used to store at least one piece of return condition information corresponding to each piece of purchase information.

3. The method of claim 2, wherein the matching the purchase information with configuration information in a return database and determining a target return condition corresponding to the item comprises:
matching the purchase information of the item with a plurality of pieces of purchase information in the master table of purchase information configuration, and determining a purchase information identifier corresponding to successfully matched purchase information;
querying, in the secondary table of return condition, a candidate return condition corresponding to the purchase information identifier; and
in response to finding that at least two candidate return conditions corresponding to the purchase information identifier exist, determining a target return condition corresponding to the item according to priority information corresponding to each candidate return condition of the at least two candidate return conditions.

4. The method of claim 1, wherein
the obtaining purchase information of an item comprises:
obtaining purchase information corresponding to an item group predetermined, wherein the item group comprises at least two items, and the at least two items correspond same purchase information;
the matching the purchase information with configuration information in a return database and determining a target return condition corresponding to the item comprises:
matching the purchase information corresponding to the item group predetermined with configuration information in the return database and determining a target return condition corresponding to the item group predetermined; and
the generating a return task corresponding to the item in response to detecting that the target return condition corresponding to the item is met comprises:
generating a return task for at least one item in the item group predetermined in response to detecting that the target return condition corresponding to the at least one item is met.

5. The method of claim 4, wherein the obtaining purchase information corresponding to an item group predetermined comprises:
combining and grouping a plurality of items according to purchase information of the plurality of items and based on a plurality of purchase parameters, and determining a plurality of item groups and purchase information corresponding to the item group predetermined in the plurality of item groups.

6. The method of claim 4, wherein the generating a return task for at least one item in the item group predetermined in response to detecting that the target return condition corresponding to the at least one item is met comprises:
detecting whether the target return condition corresponding to each item in the item group predetermined is met according to inventory information of each respective item in the item group predetermined; and
generating, according to the inventory information corresponding to each target item whose respective target return condition is met, at least one return task corresponding to the target item.

7. The method of claim 1, after the generating a return task corresponding to the item, further comprising:
controlling a sorting device to sort the item based on the return task; and
controlling a return device to perform a return operation on the sorted item when the sorting is completed.

8. (canceled)

9. A device, comprising:
at least one processor; and
a memory, configured to store at least one program;
wherein when the at least one program is executed by the at least one processor, the at least one processor implements;
obtaining purchase information of an item;
matching the purchase information with configuration information in a return database, and determining a target return condition corresponding to the item; wherein the configuration information comprises return condition information respectively corresponding to at least one piece of purchase information; and
generating a return task corresponding to the item in response to detecting that the target return condition corresponding to the item is met.

10. A non-transitory computer-readable storage medium storing a computer program, wherein, when the computer program is executed by a processor, the computer program causes the processor to implement:
obtaining purchase information of an item;
matching the purchase information with configuration information in a return database, and determining a target return condition corresponding to the item; wherein the configuration information comprises return condition information respectively corresponding to at least one piece of purchase information; and
generating a return task corresponding to the item in response to the item in response to detecting that the target return condition corresponding to the item is met.

11. The device of claim 9, wherein the return database comprises a master table of purchase information configuration and a secondary table of return condition; and wherein,
the master table of purchase information configuration is used to store at least one piece of purchase information; and
the secondary table of return condition is used to store at least one piece of return condition information corresponding to each piece of purchase information.

12. The device of claim 11, wherein when the at least one program is executed by the at least one processor, the at least one processor implements:
matching the purchase information of the item with a plurality of pieces of purchase information in the master table of purchase information configuration, and determining a purchase information identifier corresponding to successfully matched purchase information;
querying, in the secondary table of return condition, a candidate return condition corresponding to the purchase information identifier; and
in response to finding that at least two candidate return conditions corresponding to the purchase information identifier exist, determining a target return condition corresponding to the item according to priority information corresponding to each candidate return condition of the at least two candidate return conditions.

13. The device of claim 9, wherein when the at least one program is executed by the at least one processor, the at least one processor implements:
obtaining purchase information corresponding to an item group predetermined, wherein the item group comprises at least two items, and the at least two items correspond same purchase information;
wherein when the at least one program is executed by the at least one processor, the at least one processor implements:
matching the purchase information corresponding to the item group predetermined with configuration information in the return database and determining a target return condition corresponding to the item group predetermined; and
wherein when the at least one program is executed by the at least one processor, the at least one processor implements:
generating a return task for at least one item in the item group predetermined in response to detecting that the target return condition corresponding to the at least one item is met.

14. The device of claim 13, wherein when the at least one program is executed by the at least one processor, the at least one processor implements:
combining and grouping a plurality of items according to purchase information of the plurality of items and based on a plurality of purchase parameters, and determining a plurality of item groups and purchase information corresponding to the item group predetermined in the plurality of item groups.

15. The device of claim 13, wherein when the at least one program is executed by the at least one processor, the at least one processor implements:
detecting whether the target return condition corresponding to each item in the item group predetermined is met according to inventory information of each respective item in the item group predetermined; and
generating, according to the inventory information corresponding to each target item whose respective target return condition is met, at least one return task corresponding to the target item.

16. The device of claim 9, wherein when the at least one program is executed by the at least one processor, the at least one processor further implements:
controlling a sorting device to sort the item based on the return task; and
controlling a return device to perform a return operation on the sorted item when the sorting is completed.

17. The non-transitory computer-readable storage medium according to claim 10, wherein the return database comprises a master table of purchase information configuration and a secondary table of return condition; and wherein,
the master table of purchase information configuration is used to store at least one piece of purchase information; and
the secondary table of return condition is used to store at least one piece of return condition information corresponding to each piece of purchase information.

18. The non-transitory computer-readable storage medium according to claim 17, wherein, when the computer program is executed by a processor, the computer program causes the processor to implement:
matching the purchase information of the item with a plurality of pieces of purchase information in the master table of purchase information configuration, and determining a purchase information identifier corresponding to successfully matched purchase information;
querying, in the secondary table of return condition, a candidate return condition corresponding to the purchase information identifier; and
in response to finding that at least two candidate return conditions corresponding to the purchase information identifier exist, determining a target return condition corresponding to the item according to priority information corresponding to each candidate return condition of the at least two candidate return conditions.

19. The non-transitory computer-readable storage medium according to claim 10, wherein, when the computer program is executed by a processor, the computer program causes the processor to implement:
obtaining purchase information corresponding to an item group predetermined, wherein the item group comprises at least two items, and the at least two items correspond same purchase information;
matching the purchase information corresponding to the item group predetermined with configuration information in the return database and determining a target return condition corresponding to the item group predetermined; and
generating a return task for at least one item in the item group predetermined in response to detecting that the target return condition corresponding to the at least one item is met.

20. The non-transitory computer-readable storage medium according to claim 19, wherein, when the computer program is executed by a processor, the computer program causes the processor to implement:
combining and grouping a plurality of items according to purchase information of the plurality of items and based on a plurality of purchase parameters, and determining a plurality of item groups and purchase information corresponding to the item group predetermined in the plurality of item groups.

21. The non-transitory computer-readable storage medium according to claim 19, wherein, when the computer program is executed by a processor, the computer program causes the processor to implement:
detecting whether the target return condition corresponding to each item in the item group predetermined is met according to inventory information of each respective item in the item group predetermined; and
generating, according to the inventory information corresponding to each target item whose respective target return condition is met, at least one return task corresponding to the target item.
